(19) United States
(12) Patent Application Publication
(10) Pub. No.: US 2003/0131144 A1
(43) Pub. Date: Jul. 10, 2003

(54) Data wedge

(75) Inventor: Scott James Weaver, Lawrenceville, GA (US)

Correspondence Address: PAUL W. MARTIN, LAW DEPARTMENT, WHQ-5E, 1700 S. PATTERSON BLVD., DAYTON, OH, 45479-0001, US

(73) Assignee: NCR Corporation

(21) Appl. No.: 10/041,743

(22) Filed: Jan. 10, 2002

(51) Int. Cl. G06F 9/46; G06F 9/00; G06F 15/00

(52) U.S. Cl. 709/318; 709/328; 715/513

(57) ABSTRACT

The Data Wedge provides the ability to abstract interface method calls based upon functionality between components. This abstraction reduces, if not eliminates, the need to modify existing component code in order to integrate the component with others. This abstraction can be viewed as changing a function call into a function to publish data to other components and a function to subscribe into published data from other components. A result of this implementation is a highly organized and documented internal component data. The data must be organized and documented in an XML schema format in order to use the wedge, thereby reducing support and maintenance costs.

### FIELD OF THE INVENTION

The present invention relates generally to building software components with reduced or eliminated software changes when integrating software components.

### BACKGROUND ART

The costs involved with modifying large software components which are both “stable” and “fieldtested” is typically very large. These costs include development, testing, deployment, and maintenance. In addition, as technology advances, so does the demand for new and enhanced functionality from existing software components. A software component which never offers any new functionality will eventually be replaced by another software component providing the new functionality. The problem is enabling the addition of new functionality to software components while at the same time minimizing, if not eliminating, the need to modify the software component's source code. One attempt at solving this problem is known as the Component Object Model (COM), as described by Microsoft.

Component Object Model

Software component integration has largely been addressed by the Component Object Model definition. The COM defines a standard method to expose or make available to other components a software component's functionality through the use of interfaces. A software component which exposes functionality to be reused by another component is called a “server”. The component which reuses or accesses the server's functionality is called a “client”. While a software component can be both a server (offering some of its functionality for reuse) and a client (using another component's functionality), the software component takes on only one of the roles with respect to the interface being used at a certain instant of time. A first component may expose an interface (interface A) to provide functionality reuse by any other component. Furthermore, the first component may call an interface exposed by a second component (interface B) in order to reuse some of that component's functionality. While the first component is both a server and a client, it is a server with respect to interface A but a client with respect to interface B.

An interface is a “compile time contract” between software components. The server component defines an interface which offers a fixed set of functionality. The interface is implemented in the server and is called or used by client components. The interface implementation is “compiled” into the server component. Any new functionality must be exposed by the definition and implementation of a new interface by the server component. According to the COM, once an interface is defined and implemented in the server component, the interface can never be changed. This allows clients using the interface to know exactly what functionality they are getting and will always get from a particular COM interface.

This type of design requires component changes to both the client and server components when adding functionality. Even if a new server component were developed to provide all the new functionality, the client component would still have to be modified to access or call the new server component. If the client component operated independently of the server (requiring no data from the server component), it seems ironic that the client component would have to change to support new functionality offered by the new server component.

For example, suppose there is a point-of-sale software component which performs sales transactions on a point-of-sale device. Now, suppose we want to add new functionality to display the current transaction data on an auxiliary device (like a kiosk). The semantics of displaying the information would be implemented in a new component. But how does this new component obtain the transaction data? Using COM, the display component would be a server component hosting an interface called by the sales component. This means the sales component will have to be modified.

As a result of the above-identified problems and difficulties, there is a need in the art for a software component requiring reduced or eliminated software changes when integrating software components. There is a need in the art for a method of building a software component requiring reduced or eliminated software changes when a client or server component interfaced with the software component is modified.

### DISCLOSURE/SUMMARY OF THE INVENTION

It is therefore an object of the present invention to provide a software component requiring reduced or eliminated software changes when integrating software components.

Another object of the present invention is to provide a method of building a software component requiring reduced or eliminated software changes when a client or server component interfaced with the software component is modified.

Assuming the above-described sales component was already using a Data Wedge as described below to export all its transaction data as it was occurring, the new display component could be implemented by reading the transaction data through the Data Wedge so the client component wouldn't have to change. The Date Wedge provides an approach to building software components to reduce or eliminate code changes during integration of software components. Furthermore, other components could be added without modifying the sales component to do other things like print coupons based upon current transaction information, write transaction data to a data warehouse, or even new components to monitor transactions and perform specific functions based upon the transaction content. These specific functions could be related to loss prevention, customer relations, or even inventory control.

The above described objects are fulfilled by a method and system for integrating software components using a data wedge. The data wedge is an intermediary between the software components and receives schemas and data models from the software components. The wedge translates data between formats specified by the software components.

A method aspect of the present invention includes integrating a first software component with a second software component. A schema is created and integrated into a data wedge. A data model in the data wedge is populated and data elements in the data model are translated from a first format of the first software component schema to a second format of the second software component. In a further embodiment, the method triggers an event to notify the second software component of translated data element availability.

A system aspect includes a processor and a memory coupled to the processor. The memory stores data and sequences of instructions which, when executed by the processor, cause the processor to integrate software components. The instructions, when executed by the processor, further cause the processor to create a schema, integrate the schema into a data wedge, and populate a data model in the data wedge. The instructions cause the processor to translate data elements in the data model from a first format of a first software component schema to a second format of a second software component. In a further embodiment, the instructions cause the processor to trigger an event to notify the second software component of translated data element availability.

A further system aspect for integrating a first and second software component having a first and second schema respectively and a first and second data view respectively includes a data wedge configured to translate a data element from the first data view in accordance with the first schema to the second data view in accordance with the second schema. In a further embodiment, the data wedge of the system is further configured to trigger an event to notify the second software component of translated data element availability.

Still other objects and advantages of the present invention will become readily apparent to those skilled in the art from the following detailed description, wherein the preferred embodiments of the invention are shown and described, simply by way of illustration of the best mode contemplated of carrying out the invention. As will be realized, the invention is capable of other and different embodiments, and its several details are capable of modifications in various obvious respects, all without departing from the invention. Accordingly, the drawings and description thereof are to be regarded as illustrative in nature, and not as restrictive.

### BRIEF DESCRIPTION OF THE DRAWINGS

The present invention is illustrated by way of example, and not by limitation, in the figures of the accompanying drawings, wherein elements having the same reference numeral designations represent like elements throughout and wherein:

FIG. 1 is a high level block diagram of an example implementation of an embodiment of the present invention;

FIG. 2 is a high level flow chart of an example implementation of the process flow of an embodiment of the present invention; and

FIG. 3 is a high level block diagram of an example computer system usable with an embodiment of the present invention.

### BEST MODE FOR CARRYING OUT THE INVENTION

A method and apparatus for building software components while reducing or eliminating software changes when integrating or modifying software components is described. In the following description, for purposes of explanation, numerous specific details are set forth in order to provide a thorough understanding of the present invention. It will be apparent; however, that the present invention may be practiced without these specific details. In other instances, well-known structures and devices are shown in block diagram form in order to avoid unnecessarily obscuring the present invention.

The present invention discloses an approach to building software components such that code changes may be reduced or even eliminated when integrating or modifying software components regardless of the functionality they provide. This approach requires the use of a “data proxy” software component called a Data Wedge or Wedge. The Wedge attempts to “wedge” data from one software component into another where it can be used, modified, and returned much like an interface method call. However, the data can be moved between components transparently so that each component can operate independently of other components. Furthermore, it provides the ability to expose any internal data such that future components which may require that data can be integrated without code change to the components.

Top Level Description

The Data Wedge attempts to minimize code modification requirements when integrating software components by utilizing a data model of cooperating components instead of functional interfaces. Through the use of COM, the Wedge exposes fixed compile time interfaces for clients to use. However, these interfaces have nothing to do with the functionality provided among software components. Instead, they provide a mechanism for components to transparently share their data with other components.

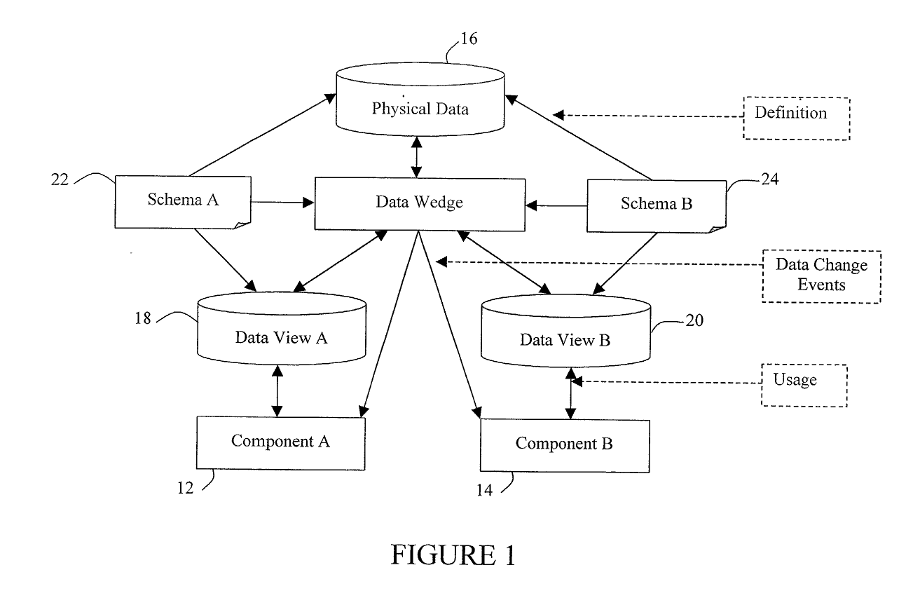

As shown in FIG. 1, the Wedge 10 acts as a server component to all other components, i.e., component A 12 and component B 14, by providing data from a physical data store 16. The client components 12 and 14 use the wedge 10 to manage their data, i.e., data view A 18 and data view B 20, and to get notified of incoming data from other components (not shown). Each component's data (data view A 18 for component A 12 and data view B 20 for component B 14) is mapped by wedge 10 from the physical data 16 according to the appropriate component-provided schema, i.e., schema A 22 for component A 12 data and schema B 24 for component B 14 data. The logical structure of the data as viewed by all clients is a tree structure. This tree structure is modeled after the World Wide Web Consortium (W3C) Extensible Markup Language (XML) Data Object Model (DOM) Level 2 specification to closely match an evolving standard for data representation and access. This specification falls short of what the Wedge 10 provides because it only specifies a single view of the physical data 16. The Wedge 10 provides a different view of the physical data 16 to every client or component 12 and 14 and also provides the mechanism to move and translate data between the views 18 and 20. The Wedge 10 adds a third dimension on top of the existing specification. The depth of that third dimension is always equal to the number of clients (e.g., 12 and 14) connected.

Each client component must define its logical view of the data (its data model) and provide this definition to the Wedge upon connection. This definition is in the form of a superset of the XML schema definition specified in the W3C XML Schema working draft. The XML Schema definition may be found at http://www.w3.org/xml/schema. The Wedge definition format includes additional vocabulary to specify new properties of data elements. The new properties include component permissions (specifying which outside components can read/write to/from which elements), data triggers (specifying which elements fire change events and how those events will be labeled), translation (specifying how to translate complex structures between components), and external linkage (specifying the mapping of locally named structures to the content of external component models).

An instance of the Wedge is defined by an instance identifier and a name identifier. The name is identified in the schema while the instance identifier is provided by the client component at runtime. This allows multiple instances of the same data model to exist concurrently. Each Wedge manages a single data structure for all its clients (who will be connected to the same name and instance). It also manages each client's view of the data and initiates any data events as specified in the clients' schemas. The Wedge acts as an object factory providing node and element objects to its clients. These objects provide the component-specific logical view of the shared physical data. Just like in the XML DOM, these objects provide access to their underlying data and their definition (data type and content). However, the wedge manufactures these objects with additional information pertaining to other clients' models such that when they are modified, they are translated into the model of other clients as needed and appropriate events are triggered.

Data Wedge Vocabulary

The Wedge data format definition is specified as a superset of the W3C XML Schema working draft. The schema draft defines a vocabulary for specifying data format and content. The Wedge enhances this vocabulary by including the ability to specify:

1. Data Translation—The Wedge provides the ability for clients to add data to their data model and have it translated into additional formats and inserted into their own data model or the data model of other components connected to the same Wedge instance. This is specified in the schema.

2. Data Protection—The Wedge provides the ability to identify data elements which can be read and modified by other software components and to identify those components. This specification is contained within the schema.

3. Event Notification—The Wedge provides the ability to identify which data elements will fire events when they are modified and the event labels. The event labels allow the client to easily identify the type of data modified. The event information is specified in the schema.

4. Data Sharing—The Wedge provides the ability to map data elements from one component to another. In effect, both components share the same physical data but have separate views of shared elements. This is the main method of communication between wedge clients and how the data elements map between component data models is specified in the schema. A data producing client will tag elements with multiple names. One of those names will be the local name which is used by the client for data access. The other names are external names which are the names subscribing clients will use to map their local names.

5. Complex Data Types—The Wedge provides the ability to define structures with a contained element tagged as the “key” element of the structure. This element does not have to be a direct child of the structure being defined but must be a direct descendant. With this data type, the Wedge supports the concept of a record set data type that contains only keyed structures with each structure containing a unique key. Another data type supported is a “virtual” structure. This structure is defined with the standard <archtype>tag but can be created and populated by a client even though it is a “definition” rather than a “declaration”. When this type of structure is inserted into the model it is first used for translation into the local and external models. Then, the structure is discarded (not inserted and destroyed once all references to it have been released). This allows a component to create its own mini-data model which is not translated until it is inserted into its real data model and the mini-data model is emptied. This is useful for adding large amounts of data at one time which must be translated into multiple local subsets within the model.

The current vocabulary set is beyond the scope of this document. Furthermore, it is constantly being enhanced to support common data requirements between clients as they arise. For instance, multiple clients need to calculate the current date and time for data model population. This leads to a new “datetime” specification in the schema that informs the wedge to insert the current data and time into the element where it is defined when that element is created. The wedge is designed to allow simple integration of new schema specifications to perform common tasks.

This document will not describe current schema formats since the core format can be obtained through the W3C XML Schema working draft. As described above, the wedge format simply supports a richer vocabulary than is contained within the draft.

Function Replacement

With the use of the Data Wedge, function calls or interface method calls to server components are no longer necessary. Instead, client components populate their data model with the data required by the server component to perform its task. The server component receives an event from the Wedge when the data is available (it is first translated into the server's data model). This event causes the server to read the data and perform its task. If the task involves return data, the server writes the data to its model where it is translated back to the client's model. If the client had used an asynchronous mapping it would be off and executing other things when the server returns its results. However, when the results are returned and mapped back into the client's model, the client receives an event signifying completion (assuming the event was specified in its schema). At this point, the client reads the returned results from its data model.

To reduce or eliminate future code changes, a client would populate its data model with any data that is “useful” and which may be required by a future component. If the client could allow modifications to some of its data elements in the future, it would read and write the values of these elements through the Wedge so that when they are modified, the client would not have to change to use the modified data.

Process Flow

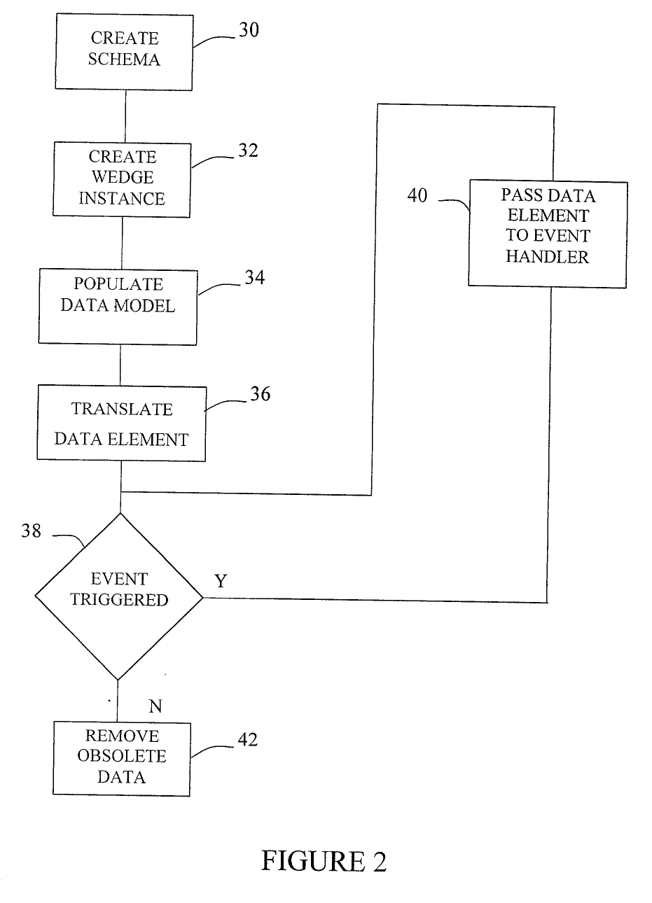

A process flow of a software component or client, e.g., component A12, using the Wedge 10 is described with reference to FIG. 2.

In step 30, a client that uses the Wedge must first create a schema describing its logical data model. The schema contains the format and content of the data as well as a Wedge name. The Wedge name is used to connect component schemas together.

Once the schema is defined, the client creates an instance of the Wedge in step 32 by providing its schema and an optional instance identifier. If a Wedge already exists with the same name/instance pair, the schema is dynamically integrated into that Wedge and returned to the client for use. Otherwise, a new Wedge composed of the single schema is created and returned to the client.

At this step in the process, the client has a reference to the Wedge and the Wedge has at least a single empty named element in the clients data model. The Wedge also has any first level default data values and elements, as specified in the schema.

In step 34, the client component then populates its data model, e.g., data view A18, by requesting the creation of a data element through the Wedge by its local name as specified in the schema. The Wedge returns an object representing that data element to the client where it is populated. These objects follow schema format and content rules during population preventing incorrect population by the client. Once the element is completely populated in step 34, the client inserts the element into its data model in step 36 where it is then translated into other component data models as needed. It is important to note that the only data shared among components is the data actually in the model. Clients can modify data already in their model directly but that becomes expensive in terms of performance since each modification could require translation across multiple additional models. It is more efficient for clients to populate their data structures outside of the model and then insert them once complete.

When data is inserted into a client's model (or directly modified), the Wedge translates the data into other formats necessary within that same model and into the models of other “subscribing” components. Modification of any data within any model has the potential of triggering an event (a COM event) as dictated by the governing schema which is tested at step 38 of the flow. If a schema specifies an event to be thrown or triggered on a modified data element, the flow of control proceeds to step 40 and the data element that was modified along with an event tag specified in the schema is passed to the event handler (if there is one). This notifies a subscriber that new information is available and it can process whatever data is needed. Upon completion of step 40, the flow of control returns to step 38. The subscriber could then repeat this process in the other direction to complete a round-trip function call by execution of step 38. In this way, a subscriber could then act as the client and the client as a subscriber. This is how data is passed from one component to another and then returned to the original component in a modified state.

The flow of control proceeds to step 42 wherein when data in the model becomes obsolete, the client is responsible for removing the data. The Wedge is not designed to be a large data container. It is designed to manage small amounts of data having limited lifetimes.

Internal Organization

The Data Wedge attempts to minimize the amount of data which must be retained to support multiple logical views of the data between components. Therefore, a single structure called a data document is used to store all data elements. The data document contains internally generated tags but the actual data content is supplied by the client components. Each component data model is supported by its own copy of a “view document” mapping the component's tags to the internally generated tags in the data document. The view document also carries all of its schema information. Namespace prefixes as required in the Wedge schema format identify components used internally to track data flow routes. A data flow route is the path through all the view documents a data document element must flow when it is modified.

Hardware Overview

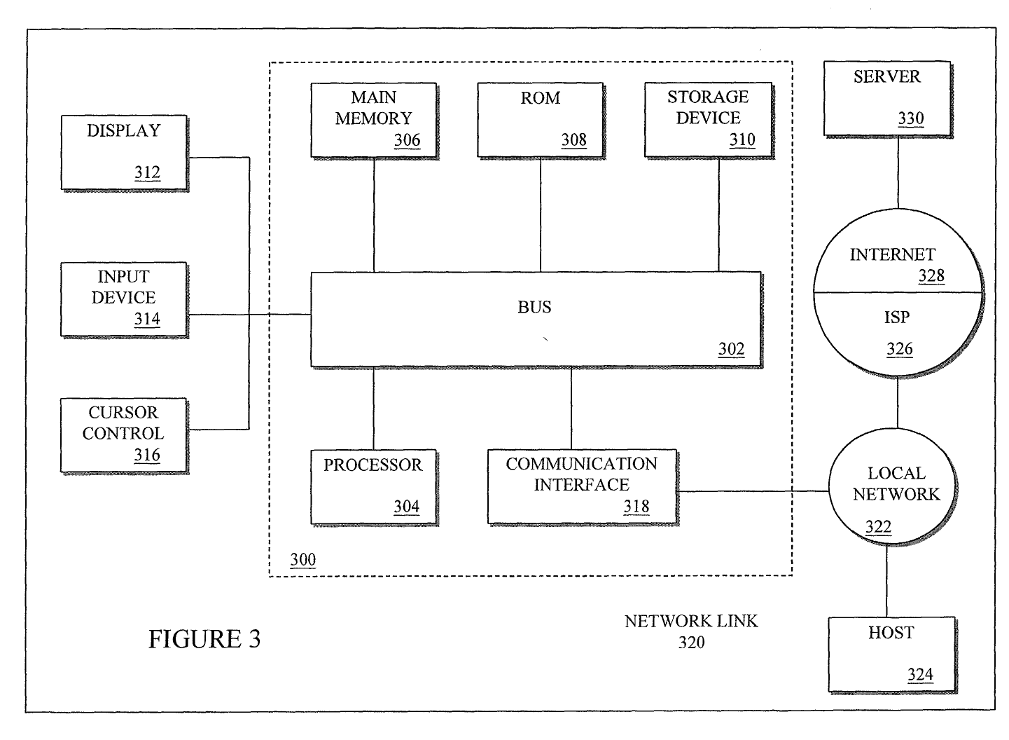

FIG. 3 is a block diagram illustrating an exemplary computer system 300 upon which an embodiment of the invention may be implemented. The present invention is usable with currently available personal computers, mini-mainframes and the like.

Computer system 300 includes a bus 302 or other communication mechanism for communicating information, and a processor 304 coupled with the bus 302 for processing information. Computer system 300 also includes a main memory 306, such as a random access memory (RAM) or other dynamic storage device, coupled to the bus 302 for storing transaction and interaction data, and instructions to be executed by processor 304. Main memory 306 also may be used for storing temporary variables or other intermediate information during execution of instructions to be executed by processor 304. Computer system 300 further includes a read only memory (ROM) 308 or other static storage device coupled to the bus 302 for storing static information and instructions for the processor 304. A storage device 310, such as a magnetic disk or optical disk, is provided and coupled to the bus 302 for storing transaction and interaction data, inventory data, orders data, and instructions.

Computer system 300 may be coupled via the bus 302 to a display 312, such as a cathode ray tube (CRT) or a flat panel display, for reducing or eliminating software changes when integrating components. An input device 314, including alphanumeric and function keys, is coupled to the bus 302 for communicating information and command selections to the processor 304. Another type of user input device is cursor control 316, such as a mouse, a trackball, or cursor direction keys for communicating direction information and command selections to processor 304 and for controlling cursor movement on the display 312. This input device typically has two degrees of freedom in two axes, a first axis (e.g., x) and a second axis (e.g., y) allowing the device to specify positions in a plane.

The invention is related to the use of computer system 300, such as the illustrated system of FIG. 3 to reduce or eliminate software changes when integrating software components. According to one embodiment of the invention, the data view, schema, and physical data are tracked by computer system 300 in response to processor 304 executing sequences of instructions contained in main memory 306 in response to input received via input device 314, cursor control 316, or communication interface 318. Such instructions may be read into main memory 306 from another computer-readable medium, such as storage device 310.

However, the computer-readable medium is not limited to devices such as storage device 310. For example, the computer-readable medium may include a floppy disk, a flexible disk, hard disk, magnetic tape, or any other magnetic medium, a CDROM, any other optical medium, punch cards, paper tape, any other physical medium with patterns of holes, a RAM, a PROM, an EPROM, a FLASH-EPROM, any other memory chip or cartridge, a carrier wave embodied in an electrical, electromagnetic, infrared, or optical signal, or any other medium from which a computer can read. Execution of the sequences of instructions contained in the main memory 306 causes the processor 304 to perform the process steps described below. In alternative embodiments, hard-wired circuitry may be used in place of or in combination with computer software instructions to implement the invention. Thus, embodiments of the invention are not limited to any specific combination of hardware circuitry and software.

Computer system 300 also includes a communication interface 318 coupled to the bus 302. Communication interface 308 provides two-way data communication as is known. For example, communication interface 318 may be an integrated services digital network (ISDN) card, a digital subscriber line (DSL) card, or a modem to provide a data communication connection to a corresponding type of telephone line. As another example, communication interface 318 may be a local area network (LAN) card to provide a data communication connection to a compatible LAN. Wireless links may also be implemented. In any such implementation, communication interface 318 sends and receives electrical, electromagnetic or optical signals which carry digital data streams representing various types of information. Of particular note, the communications through interface 318 may permit transmission or receipt of instructions and data, e.g., server data, Wedge data, and client data models and specifications. For example, two or more computer systems 300 may be networked together in a conventional manner with each using the communication interface 318.

Network link 320 typically provides data communication through one or more networks to other data devices. For example, network link 320 may provide a connection through local network 322 to a host computer 324 or to data equipment operated by an Internet Service Provider (ISP) 326. ISP 326 in turn provides data communication services through the world wide packet data communication network now commonly referred to as the “Internet” 328. Local network 322 and Internet 328 both use electrical, electromagnetic or optical signals which carry digital data streams. The signals through the various networks and the signals on network link 320 and through communication interface 318, which carry the digital data to and from computer system 300, are exemplary forms of carrier waves transporting the information.

Computer system 300 can send messages and receive data, including program code, through the network(s), network link 320 and communication interface 318. In the Internet example, a server 330 might transmit a requested code for an application program through Internet 328, ISP 326, local network 322 and communication interface 318. In accordance with the invention, one such downloaded application provides for integrating software components.

The received code may be executed by processor 304 as it is received, and/or stored in storage device 310, or other non-volatile storage for later execution. In this manner, computer system 300 may obtain application code in the form of a carrier wave.

The specification provided illustrates an implementation of the method. The method is described as developing software components operating solely on data model events and using a data wedge component to manage the data models through the use of an external data definition (schema used in implementation) such that desired functionality is achieved by modifying only the external data definition, and requiring no code changes.

It will be readily seen by one of ordinary skill in the art that the present invention fulfills all of the objects set forth above. After reading the foregoing specification, one of ordinary skill will be able to effect various changes, substitutions of equivalents and various other aspects of the invention as broadly disclosed herein. It is therefore intended that the protection granted hereon be limited only by the definition contained in the appended claims and equivalents thereof.

What is claimed is:

1. A method of integrating a first software component with a second software component, the method comprising the steps of:
creating a schema;
integrating the schema into a data wedge;
populating a data model in the data wedge; and
translating data elements in the data model from a first format of the first software component schema to a second format of the second software component.

2. The method as claimed in claim 1, further comprising the step of:
triggering an event to notify the second software component of translated data element availability.

3. The method as claimed in claim 1, further comprising the step of:
removing obsolete data elements from the data model.

4. The method as claimed in claim 1, further comprising the step of:
creating an instance of a data wedge.

5. The method as claimed in claim 1, wherein the schema created includes a data model and a data wedge name.

6. The method as claimed in claim 1, wherein integrating the schema into the data wedge includes setting default data elements and data values.

7. The method as claimed in claim 1, further comprising the step of:
modifying a data element in the data model of the first software component.

8. A computer system for integrating software components comprising:
a processor; and
a memory coupled to said processor; the memory having stored therein data and sequences of instructions which, when executed by said processor, cause said processor to integrate software components by causing the processor to:
create a schema, integrate the schema into a data wedge, populate a data model in the data wedge, and translate data elements in the data model from a first format of a first software component schema to a second format of a second software component.

9. The system as claimed in claim 8, further comprising instructions which, when executed by said processor, cause said processor to:
trigger an event to notify the second software component of translated data element availability.

10. The system as claimed in claim 8, further comprising instructions which, when executed by said processor, cause said processor to:
remove obsolete data elements from the data model.

11. The system as claimed in claim 8, further comprising instructions which, when executed by said processor, cause said processor to:
create an instance of a data wedge.

12. The system as claimed in claim 8, further comprising instructions which, when executed by said processor, cause said processor to:
modify a data element in the data model of the first software component.

13. The system as claimed in claim 8, wherein the schema created includes a data model and a data wedge name.

14. The method as claimed in claim 8, wherein integrating the schema into the data wedge includes setting default data elements and data values.

15. A computer implemented system for integrating a first and second software component having a first and second schema respectively and a first and second data view respectively, the system comprising:
a data wedge configured to translate a data element from the first data view in accordance with the first schema to the second data view in accordance with the second schema.

16. The system as claimed in claim 15, wherein said data wedge is further configured to trigger an event to notify the second software component of translated data element availability.
